(19) United States
(12) Patent Application Publication
(10) Pub. No.: US 2023/0406984 A1
(43) Pub. Date: Dec. 21, 2023

(54) UV-CURABLE RESINS FOR CHEMICAL MECHANICAL POLISHING PADS

(71) Applicant: CMC Materials LLC, Aurora, IL (US)

(72) Inventor: Ping HUANG, Naperville, IL (US)

(21) Appl. No.: 18/210,438

(22) Filed: Jun. 15, 2023

Related U.S. Application Data
(60) Provisional application No. 63/352,263, filed on Jun. 15, 2022.

(51) Int. Cl. C08F 290/06; B24D 11/00; C08K 5/5397

(52) U.S. Cl. CPC C08F 290/067; B24D 11/003; C08K 5/5397

(57) ABSTRACT

The invention provides a composition for preparing a chemical-mechanical polishing pad via photopolymerization, comprising one or more acrylate urethane oligomers, one or more acrylate monomers and at least one photo-polymerization initiator. The invention also provides a method of forming a chemical-mechanical polishing pad comprising; preparing composition comprising one or more acrylate urethane oligomers, one or more acrylate monomers and at least one photo-polymerization initiator. The method further comprising exposing at least a layer of the composition to ultraviolet light, thereby initiating a polymerization reaction and thus forming at least a layer of solidified pad material.

### TECHNICAL FIELD

This disclosure generally relates to chemical mechanical polishing, and more specifically to UV-curable resins for chemical mechanical polishing pads.

### BRIEF DESCRIPTION OF FIGURES

To assist in understanding the present disclosure, reference is now made to the following description taken in conjunction with the accompanying drawings, in which:

FIG. 1 is a block diagram illustrating a composition of an improved UV-curable resin for preparing CMP pads, according to an illustrative embodiment of this disclosure;

FIG. 2A is a diagram illustrating an example reaction for synthesizing components of the composition of FIG. 1;

FIG. 2B is a diagram illustrating another example reaction for synthesizing components of the composition of FIG. 1;

FIGS. 3A-C are diagrams of chemical structures of example secondary diamines for use in the reaction of FIG. 2B;

FIG. 4 is a flowchart of an example process for preparing the composition of FIG. 1 and using the composition to prepare CMP pads;

FIG. 5 is a plot of relative wear rates achieved by CMP pads prepared with different secondary diamines used during resin preparation;

FIG. 6 is a plot of glass transition temperatures (T_{g}) of materials prepared with different secondary diamines used during resin preparation;

FIG. 7 is a plot of relative material removal rates achieved by the different sample CMP pads summarized in TABLE 1;

FIG. 8 is a plot of planarization efficiency (PE) of different sized feature achieved by the different sample CMP pads summarized in TABLE 1; and

FIG. 9 is a plot of relative groove-depth (GD) loss achieved by the different sample CMP pads summarized in TABLE 1.

### DETAILED DESCRIPTION

It should be understood at the outset that, although example implementations of embodiments of the disclosure are illustrated below, the present disclosure may be implemented using any number of techniques, whether currently known or not. The present disclosure should in no way be limited to the example implementations, drawings, and techniques illustrated below. Additionally, the drawings are not necessarily drawn to scale.

An integrated circuit is typically formed on a substrate by the sequential deposition of conductive, semi-conductive, and/or insulative layers on a silicon wafer. A variety of fabrication processes require planarization of at least one of these layers on the substrate. For example, for certain applications (e.g., polishing of a metal layer to form vias, plugs, and lines in the trenches of a patterned layer), an overlying layer is planarized until the top surface of a patterned layer is exposed. In other applications (e.g., planarization of a dielectric layer for photolithography), an overlying layer is polished until a desired thickness remains over the underlying layer. Chemical-mechanical planarization, also known as chemical-mechanical polishing (both referred to as “CMP”), is one accepted method of planarization. This planarization method typically requires that the substrate be mounted on a carrier head. The exposed surface of the substrate is typically placed against a polishing pad on a rotating platen. The carrier head provides a controllable load (e.g., a downward force) on the substrate to push it against the rotating polishing pad. A polishing liquid, such as slurry with abrasive particles, can also be disposed on the surface of the polishing pad during polishing.

One objective of a CMP process is to achieve a high polishing uniformity. If different areas on the substrate are polished at different rates, then it is possible for some areas of the substrate to have too much material removed (“overpolishing”) or too little material removed (“underpolishing”). Conventional polishing pads, including standard pads and fixed-abrasive pads, can suffer from these problems. A standard pad may have a polyurethane polishing layer with a roughened surface and may also include a compressible backing layer. A fixed abrasive pad has abrasive particles held in a containment media and is typically supported on an incompressible backing layer.

These conventional polishing pads are typically prepared by molding, casting or sintering polyurethane materials. Molded polishing pads must be prepared one at a time (e.g., by injection molding). For casting polishing pads, a liquid precursor is cast and cured into a “cake,” which is subsequently sliced into individual pad sections. These pad sections must then be machined to a final thickness. Polishing pads prepared using conventional extrusion-based processes generally lack desirable properties for CMP (e.g., are too brittle for effective CMP).

CMP pads can also be formed using a vat-based additive manufacturing process, as described in U.S. patent application Ser. No. 16/868,965, filed May 7, 2020 and titled “CHEMICAL MECHANICAL PLANARIZATION PADS VIA VAT-BASED PRODUCTION,” wherein a plurality of thin layers of pad material are progressively formed. Each layer of the plurality of layers may be formed via UV-initiated reaction of a precursor material to form a thin layer of solidified pad material. The resulting pad is thus formed with a precisely controlled structure by projecting an appropriate pattern of light (e.g., UV irradiation) for forming each thin layer.

The use of an additive manufacturing process provides for various benefits and advantages. For example, one advantage of using an additive manufacturing process is the ability to generate a CMP pad comprising a continuous single-layer body, in contrast to the multi-layered body formed by extrusion-based CMP processes (which require a top-sheet adhered to a sub-pad via adhesives). Additionally, additive manufacturing processes can allow polishing pads to be formed with more tightly controlled physical and chemical properties than is possible using other conventional processes. For example, the process allows CMP pads to be prepared with unique groove and channel structures depending on the UV light image projected on the surface. The patterns on the layers can be applied by a computer aided design (CAD) program that controls the projected UV image pattern. The process also facilitates increased manufacturing throughput than is possible using other methods, including extrusion-based printing processes (e.g., processes involving a mechanical printhead with nozzles that eject precursor material onto a surface as the printhead is moved). The additive manufacturing process also reduces machine operation costs, material costs and labor costs, while also reducing the likelihood of human error.

The present disclosure seeks to improve upon existing CMP processes by providing an improved CMP pad made of a new UV-curable resin. In particular, the present disclosure is directed to an improved UV-curable resin for preparing CMP pads. The resin includes one or more acrylate urethane oligomers, one or more acrylate monomers, at least one photo-polymerization initiator, and optional additives, such as porogen fillers and pigments. The acrylate urethane oligomer may be prepared from a secondary diamine-coupled urethane prepolymer. This disclosure recognizes that a major constraint for the use of UV-curable resins for preparing CMP pads is the brittleness introduced by acrylate components. Brittle materials, such as those that may be prepare using a (meth)acrylate blocked polyurethane, display higher wear rates and thus have shorter useful lifetimes. The new UV-curable material of this disclosure can be used to prepare CMP pads with improved wear rates, while maintaining high removal rates and good planarization efficiency.

The improved UV-curable resin of this disclosure facilitates the efficient preparation of CMP pads using additive manufacturing processes, such as vat-based processes, roll coating processes, and the like. In certain embodiments, the resulting CMP pads display significantly lower wear rates than those of CMP pads prepared using acrylate urethane prepolymers with a secondary diamine-based coupling. CMP pads of this disclosure have improved chemical and mechanical properties compared to those of previous CMP pads and display beneficial performance properties, such as high material removal rates and increased planarization efficiencies. The CMP pads can also be prepared more efficiently and reliably than previous CMP pads.

It is also an object of this disclosure to provide a process for the preparation of CMP pads using a UV-curable resin that includes one or more acrylate urethane oligomers, one or more acrylate monomers, at least one photo-polymerization initiator, and optional additives, such as porogen fillers and pigments. In some embodiments, at least one of the acrylate urethane oligomers is prepared by coupling a secondary diamine to a urethane prepolymer. In some embodiments, the molar ratio of the secondary diamine to the urethane prepolymer is 1:2.

### Example Composition

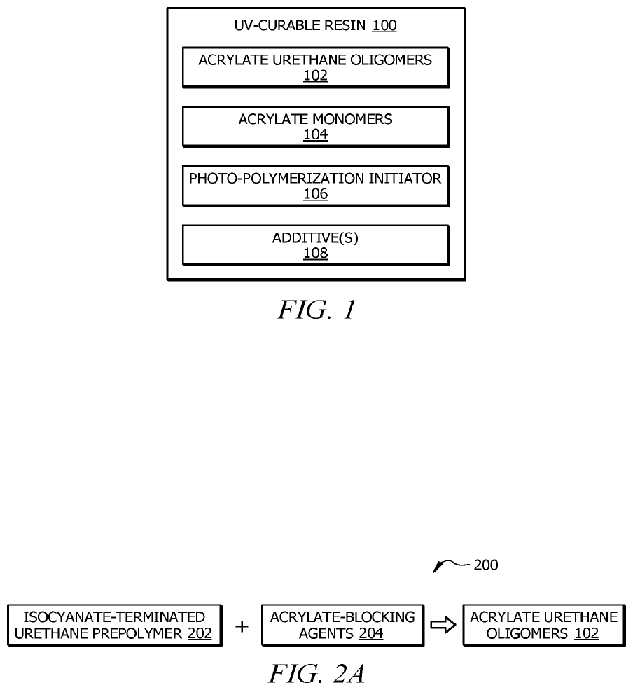

FIG. 1 illustrates an example composition of a UV-curable resin 100 for making a CMP pad. The UV-curable resin 100 is composed of a mixture that includes one or more acrylate urethane oligomers 102, one or more acrylate monomers 104, at least one photo-polymerization initiator 106, and optional additives 108.

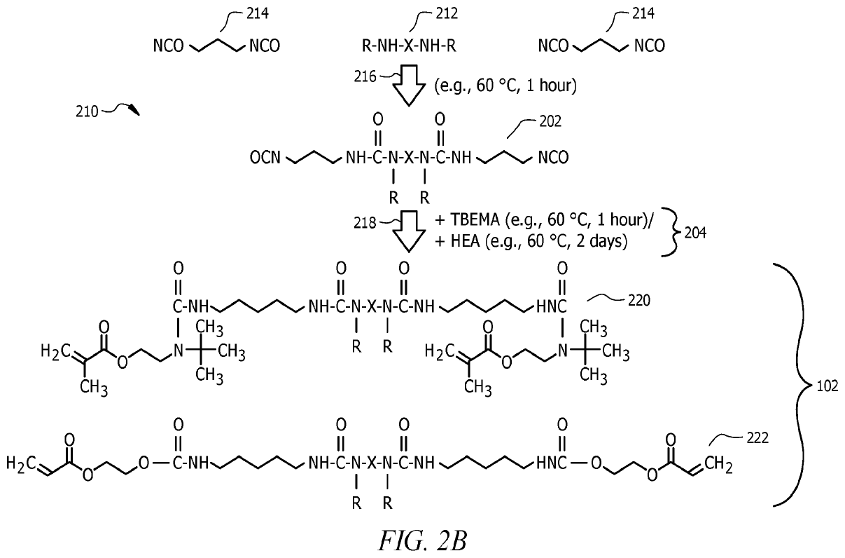

The acrylate urethane oligomers 102 may include (meth)acrylated urethane oligomers. In some embodiments, the acrylate urethane oligomers 102 are prepared by the reaction between a urethane prepolymer with an isocyanate group (i.e., an isocyanate-terminated urethane prepolymer) and one or more acrylate blocking agents. An example of such a reaction is illustrated in the example of FIG. 2A, which shows a reaction 200 between an isocyanate-terminated urethane prepolymer 202 and acrylate blocking agents 204. The acrylate blocking agents 204 may be acrylate monomers with amine or hydroxyl end groups. Example acrylate blocking agents 204 include, but are not limited to, 2-hydroxyethyl acrylate (HEA), 2-hydroxyethyl methacrylate (HEMA), 2-(tert-butylamino)ethyl methacrylate (TBEMA), and 3-(acryloyloxy)-2-hydroxypropyl methacrylate (AHPMA).

The isocyanate-terminated urethane prepolymer 202 may be a urethane prepolymer, such as an aromatic prepolymer (e.g., PET95A, PET75D, 80DPLF, or the like) or an aliphatic prepolymer (e.g., APC722, APC504, 51-95A, or the like). In some embodiments, the isocyanate-terminated urethane prepolymer 202 is prepared by coupling a secondary diamine to a urethane prepolymer, as illustrated in the example of FIG. 2B, described below.

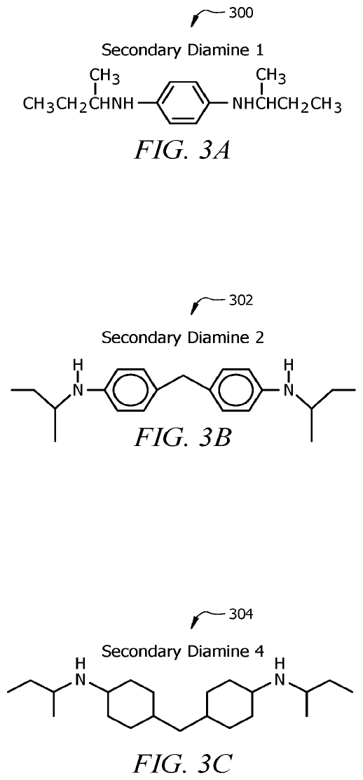

FIG. 2B shows an example reaction 210 for preparing acrylate urethane oligomers 102 that include a first oligomer 220 and a second oligomer 222. Reaction 210 includes a secondary diamine coupling reaction 216 that results in a material with a decreased brittleness and thus a lower wear rate in the resulting CMP pads. Reaction 210 introduces a degree of urea linkage to the oligomers 102 and thus reduces the acrylate linkage amount in the UV-curable resin 100, which was found to be associated with increased brittleness and rapid wear rates in CMP pads. In this example reaction 210, a secondary diamine 212 is coupled to a urethane prepolymer 214 at a 1-to-2 molar ratio. The secondary diamine 212 may be a primary amine, an aliphatic diamine (e.g., with a cyclohexane ring structure), such as Clearlink 1080 (commercially available from Dorf Ketal Chemicals), Clearlink 1000 (commercially available from Dorf Ketal Chemicals), Jeffamine 754 (commercially available from Huntsman), or an aromatic diamine (e.g., with an aromatic ring structure), such as Unilink4100 (commercially available from Dorf Ketal Chemicals), Unilink4200 (commercially available from Dorf Ketal Chemicals). This disclosure recognizes that using a secondary diamine 212 may help to achieve the desired mechanical properties of CMP pads. FIGS. 3A-C show chemical structures 300, 302, 304 of example secondary diamines 212. The urethane prepolymer 214 may be a di-isocyanate prepolymer, as illustrated in FIG. 2B.

At reaction 216, the secondary diamine 212 and urethane prepolymer 214 couple to form the longer chain isocyanate-terminated urethane prepolymer 202 (see also FIG. 2A) with a urea linkage and two isocyanate groups on the chain ends. At subsequent reaction(s) 218, the acrylate blocking agents 204 (see also FIG. 2A) are used to end-cap the isocyanate-terminated urethane prepolymer 202. By end-capping the isocyanate group of the isocyanate-terminated urethane prepolymer 202 with the acrylate blocking agent(s) 204, the isocyanate-terminated urethane prepolymer 202 is transformed into a UV-curable acrylated urethane oligomers 220, 222.

Returning to FIG. 1, the acrylate monomers 104 may act as reactive diluents to reduce the viscosity of the UV-curable resin 100. As used herein, the term acrylate can refer to methacrylates and acrylates. Acrylate monomers 104 may be mono-functional, di-functional, tri-functional, or multi-functional monomers. For example, the acrylate monomers 104 can include, but are not limited to, isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), trimethylolpropane triacrylate (TMPTA), and the like.

The photo-polymerization initiator (or photoinitiator) 106 is used to initiate the polymerization reaction in regions exposed to light (e.g., UV irradiation). The photoinitiator can be set at 365 nm or 405 nm, depending on the selected UV LED wavelength. For example, diphenylphosphine oxide (TPO) can be used as the photoinitiator, which may be irradiated by 365 nm light.

The additive(s) 108 may be added to the UV-curable resin 100 and may include stabilizers, plasticizers, porogen fillers and/or pigments (e.g., carbon black or the like). Porogens are particles (e.g., microspheres) which expand in volume when heated. Porogens may cause the formation of pores in the polishing pad, which may improve pad performance. In an embodiment, Expancel microspheres, such as 031DU40, 461DU20, and 920DU40 (commercially available from Nouryon), can be used as porogen fillers to create a porous structure in the polymer matrix. Alternatively, expanded microspheres such as Expancel DE(T) can be used as the porogen fillers. Another additive which may be used in the UV-curable resin is carbon black, a substance for adding color to the formed CMP pad.

Following exposure to UV light, the acrylate urethane oligomers 102 and acrylate monomers 104 can react via free radical polymerization in the presence of photo-polymerization initiator 106 to from a solid CMP pad. In some embodiments, an additive manufacturing technology, such as 3D printing or roll coating processing may be used to form the CMP pad. The resulting CMP pad may be treated at high temperature prior to its use.

### Example Method of Preparing CMP Pads

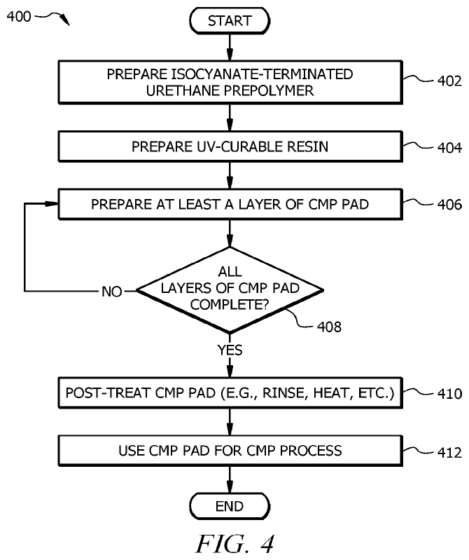

FIG. 4 illustrates an example process 400 for preparing a CMP pad using the UV-curable resin 100 of FIG. 1. In this example, a number of thin layers of pad material may be progressively formed using a vat-based additive manufacturing process or another additive manufacturing process. In some embodiments, the CMP pad may be prepared using a roll coating process. Each layer may be formed via UV-initiated reaction of the UV-curable resin 100 to form a thin layer of solidified pad material. The resulting pad is thus formed with a precisely controlled structure by projecting an appropriate pattern of light (e.g., UV irradiation) for forming each thin layer. Using process 400, CMP polishing pads can be formed with more tightly controlled physical and chemical properties than is possible using conventional processes. For example, using process 400, CMP pads can be prepared with unique groove and channel structures as well as improved chemical and mechanical properties. Process 400 also facilitates increased manufacturing throughput than is possible using conventional methods.

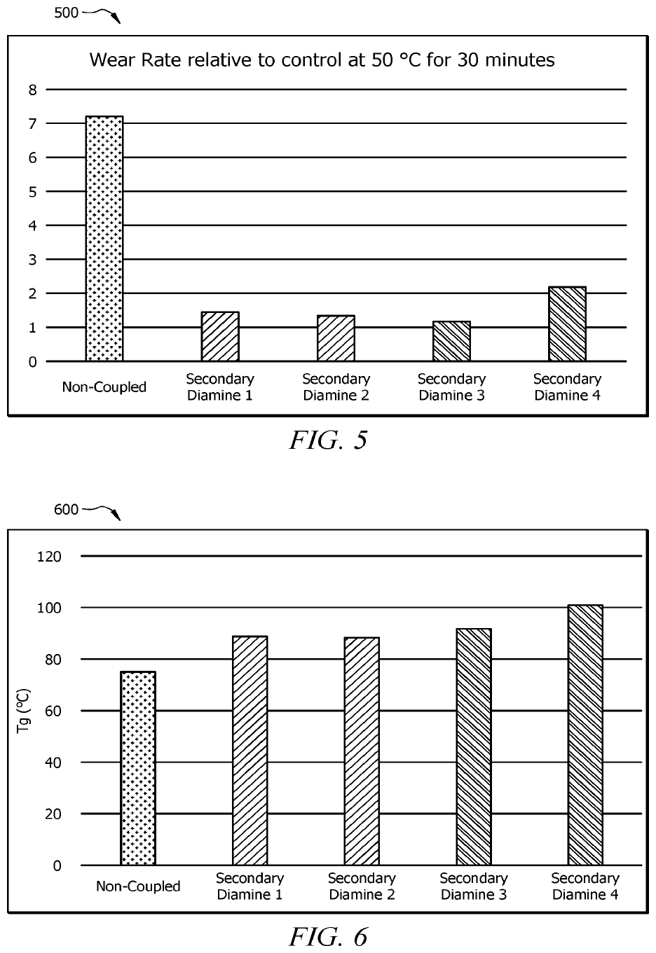

As shown in FIG. 4, at step 402, an isocyanate-terminated urethane prepolymer 202 may first be prepared. An example reaction for preparing the isocyanate-terminated urethane prepolymer 202 are illustrated in FIG. 2B. At step 404, the UV-curable resin 100 is prepared. The UV-curable resin 100 may be prepared using the isocyanate-terminated urethane prepolymer 202 from step 402. For example, the acrylate urethane oligomer(s) 102 of the UV-curable resin 100 may be prepared using the isocyanate-terminated urethane prepolymer 202, as shown in the example reaction 210 of FIG. 2B. The UV-curable resin 100 is prepared by combining the acrylate urethane oligomer(s) 102, acrylate monomer(s) 104, and photo-polymerization initiator(s) 106, each of which is described in greater detail above. Examples of UV-curable resins 100 are also described below with respect to FIGS. 5-9. To adjust the properties of the CMP pad, the UV-curable resin 100 may be combined with one or more additives 108. Suitable additives 108 include, but are not limited to, stabilizers, plasticizers, porogen fillers and/or pigments. For instance, in some embodiments, one or more porogens may be included to form pores in the CMP pad. The porogen is typically added at a weight percentage of between 1% to 30%. However, the porogen may be added at a lower or higher concentration as appropriate for a given application.

At step 406, at least one layer of a CMP pad is prepared. For example, a layer of the UV-curable resin 100 may be exposed to an appropriate pattern of UV light to create at least a layer of the CMP pad. In an example in which a vat-based additive manufacturing process is used, a build platform of the additive manufacturing apparatus may be adjusted to a desired height (e.g., of about 5, 10, 15, 20, 25, 50, 100 micrometers, or more when appropriate) relative to a surface of the vat containing at least a thin film of the UV-curable resin 100. A light source is then used to “write” the structure of the layer of the CMP pad. For example, UV light may pass through a window at the bottom of the vat that is substantially transparent to the UV light (i.e., sufficiently transparent to UV light such that the intensity of the UV light can initiate a photoinitiated reaction of the UV-curable resin 100). In general, the regions of the UV-curable resin 100 that are exposed to the UV light (i.e., based on a “write” pattern) under appropriate reaction conditions are radically polymerized. Photo-radical polymerization occurs after exposure to the UV light. Photo-radical polymerization may proceed continuously as the build platform is raised. The patterns of grooves and channels may be controlled by the pattern of the UV light projected on each layer of UV-curable resin 100 during step 406. These patterns can be controlled by a CAD program that is used to design the pattern of the projected UV light.

At step 408, a determination (e.g., by a controller or processor of the additive manufacturing apparatus used to prepare the CMP pad) is made of whether all layers of the CMP pad are complete (e.g., whether a desired pad thickness has been achieved). If the desired number of layers or thickness is not reached, the process 400 returns to step 406 and adds additional layers to the CMP pad. For the example of a vat-based process, the build platform may be moved upward again to the desired height of the next layer, which may be the same as or different than the height of the previous layer. As the build platform is moved upward, uncured UV-curable resin 100 flows beneath the cured layer. In some embodiments, the process pauses to allow an appropriate volume of resin 100 to flow (e.g., determined by the diameter of the CMP pad being manufactured and the viscosity of the resin 100). Operations are then repeated to write and cure the additional layer of the CMP pad which may include the same or a different structure (e.g., of grooves and/or channels) than the previous layer. Step 406 is repeated until a desired thickness of the CMP pad is achieved. The thickness of each layer of the CMP pad may be less than 50% of the total thickness of the CMP pad. A thickness of each layer may be less than 1% of the total thickness of the polishing pad or the polishing layer of the pad.

Once all layers of the CMP pad are complete at step 408, the process 400 proceeds to step 410. At step 410, post treatment steps may be performed to prepare the CMP pad for storage and/or use. For example, the CMP pad may be removed from its build platform and any chemical and/or physical post treatments may be performed. For example, the CMP pad may be rinsed with one or more solvents. As another example, a heat treatment may be performed to further harden the CMP pad. In some embodiments, the pad is not rinsed. In some cases, portions of the CMP pad may be backfilled with a second material, as appropriate for a given application. At step 412, the CMP pad is used for a CMP process.

### EXPERIMENTAL EXAMPLES

### A. Impact of Using Secondary Diamine Coupling on Wear Rate and Glass Transition Temperature

FIG. 5 shows a plot 500 of the normalized wear rates for different samples at 50° C. The wear rate is normalized to that of a control CMP E6088 pad (commercially available from CMC Materials, Incorporated). A “non-coupled” sample was prepared without coupling of a secondary diamine (see reaction 216 of FIG. 2B). The non-coupled sample was prepared from TBEMA-capped PET95A and HEA capped PET95A at a 3:1 ratio, IBOMA and EGDMA monomers, and TPO as photoinitiator. The remaining samples (Secondary Diamine 1-4) were prepared by coupling PET95A with various secondary diamines, blocking with TBEMA or HEA blocking agents, and photopolymerizing using TPO as photoinitiator. The “Secondary Diamine 1” sample was prepared using the aromatic secondary diamine UniLink4100, shown in FIG. 3A. The “Secondary Diamine 2” sample was prepared using the aromatic secondary diamine UniLink4200, shown in FIG. 3B. The “Secondary Diamine 3” sample was prepared using the cyclohexane-based secondary diamine ClearLink1080. The “Secondary Diamine 4” sample was prepared using the cyclohexane-based secondary diamine ClearLink1000, shown in FIG. 3C. FIG. 5 shows that samples prepared using secondary diamine coupling have lower wear rates that are similar to that of the control (i.e., with a normalized wear rate near 1), while the noncoupled sample had a much higher wear rate.

FIG. 6 shows a plot 600 of the glass transition temperature (T_{g}) of the same samples described with respect to FIG. 5. T_{g} values were measured using dynamic mechanical analysis. The non-coupled sample had the lowest T_{g} of about 75° C., while the samples prepared using secondary diamine coupling displayed T_{g} values from about 88° C. to 101° C. An increased T_{g} is generally desirable for CMP pad materials for certain applications.

### B. Performance of Example CMP Pads

A series CMP pads formulated based on the secondary diamine coupled urethane prepolymers were prepared by different manufacturing processes. TABLE 1 below shows the formulations of the UV-curable resins used to prepare the different CMP pad samples and the type of curing methods used. Sample 1 does not use secondary diamine coupling. The other four CMP pads (Samples 2-5) were prepared using a secondary diamine-coupled prepolymer. All the CMP pad samples had a hardness in the range from 53 to 66 shore D, a density in the range from 0.605 to 0.863. Samples 1 and 3-5 were prepared using a 3D printing method in which approximately 100 micrometer layers were deposited and cured sequentially. Sample 2 was prepared using a roll processing system in which the entire CMP pad was UV cured as a complete structure.

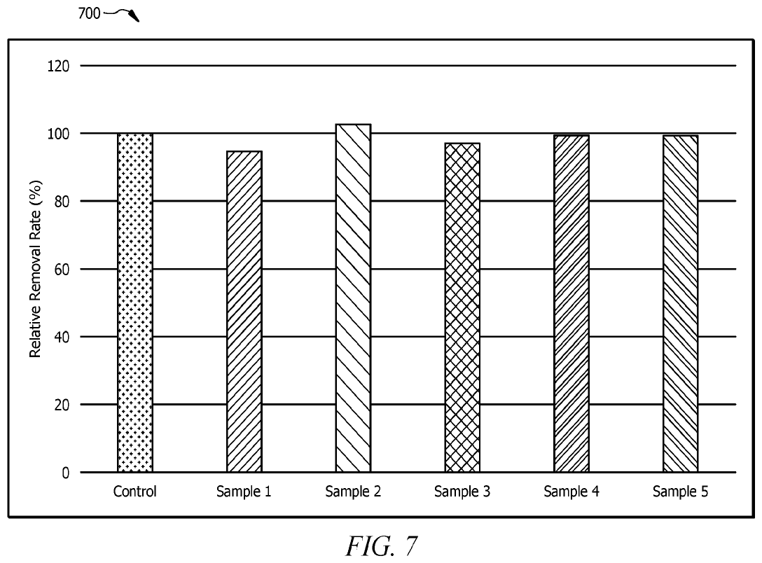

TABLE 1
Summary of Samples shown in FIGS. 7, 8, and 9.

| | | | | | | UV- |
|---|---|---|---|---|---|---|
| | Coupling | Acrylated | | | | Curing |
| Pad ID | Agent | Prepolymer | Monomer | Density | Hardness | Method |
| Sample 1 | None | 49 Part TBEMA | 33 Part IBOMA/ | 0.820 | 60 Shore D | Printed |
| | | blocked PET95A/ | 2 part EGDMA | | | |
| | | 16 Part HEA | | | | |
| | | blocked PET95A | | | | |
| Sample 2 | Clearlink1080 | 49 Part TBEMA | 33 Part IBOMA/ | 0.605 | 53 Shore D | Roll |
| | | blocked PET95A/ | 2 part EGDMA | | | Processing |
| | | 16 Part HEA | | | | |
| | | blocked PET95A | | | | |
| Sample 3 | Clearlink1080 | 49 Part TBEMA | 33 Part IBOMA/ | 0.796 | 58 Shore D | Printed |
| | | blocked PET95A/ | 2 part EGDMA | | | |
| | | 16 Part HEA | | | | |
| | | blocked PET95A | | | | |
| Sample 4 | Clearlink1080 | 49 Part TBEMA | 33 Part IBOMA/ | 0.863 | 66 Shore D | Printed |
| | | blocked PET95A/ | 2 part EGDMA | | | |
| | | 16 Part HEA | | | | |
| | | blocked PET75D | | | | |
| Sample 5 | Clearlink1000 | 49 Part TBEMA | 33 Part IBOMA/ | 0.736 | 58 Shore D | Printed |
| | | blocked PET95A/ | 2 part EGDMA | | | |
| | | 16 Part HEA | | | | |
| | | blocked PET95A | | | | |

In a variety of applications, such as shallow trench isolation (STI) and inner layer dielectric (ILD) CMP processes, high removal rate (RR) and planarization efficiency (PE) are considered to be important factors. FIG. 7 shows a plot 700 of the blanket removal rate achieved by the CMP pad samples of TABLE 1 in D7400 slurry. The E6088 pad was also tested as a control. All the UV-cured CMP pads have a comparable removal rate to that of the control. Furthermore, Samples, 2-5, which were prepared using the secondary diamine-coupled prepolymer, have better removal rates than that of Sample 1, which was prepared without using a secondary diamine-coupled prepolymer.

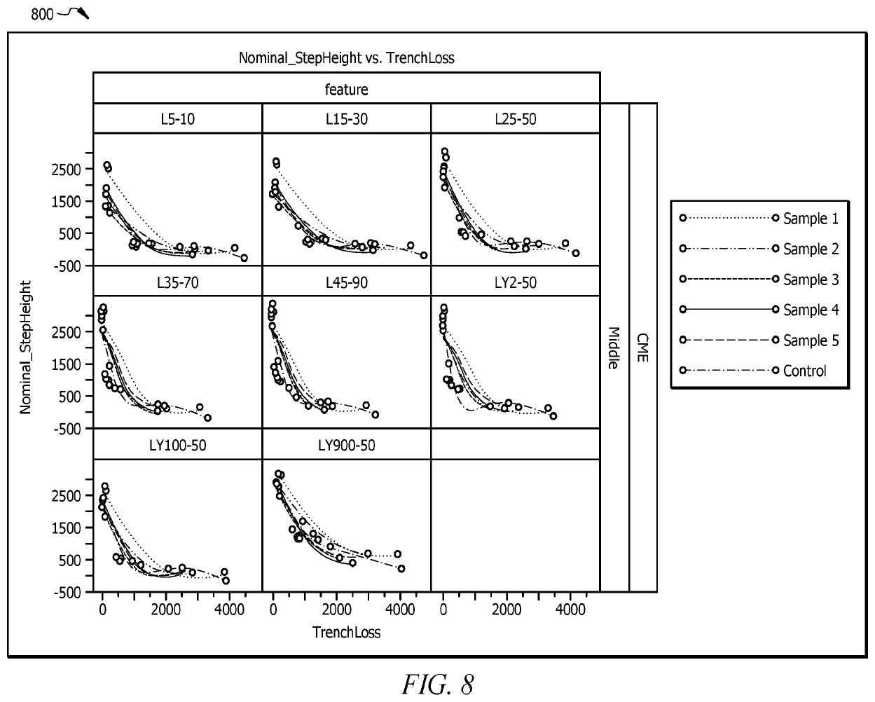

FIG. 8 shows a plot 800 of the PE of STI patterns on various sizes of features polished using the D7400 slurry. All the UV-cured CMP pad samples have a comparable PE performance to that of the control. Samples 2-5, which were prepared using a secondary diamine-coupled prepolymer had better performance than that of sample 1, which was prepared without using a secondary diamine-coupled prepolymer.

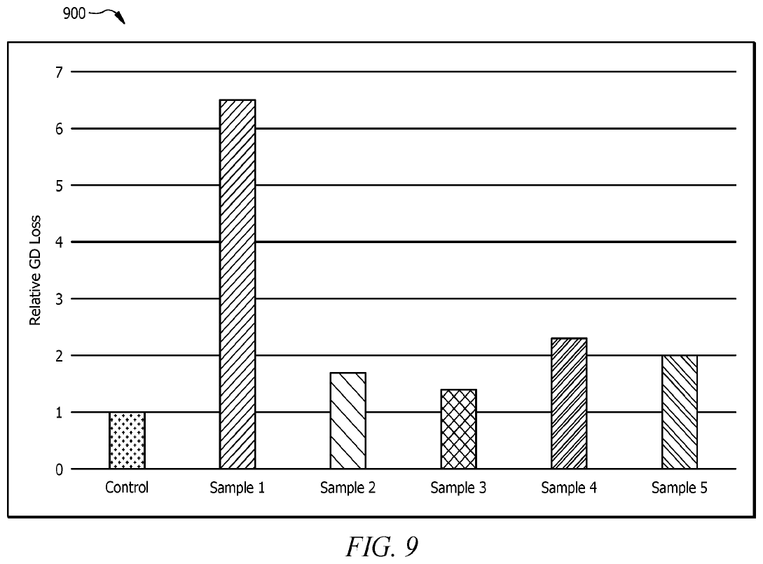

FIG. 9 shows a plot 900 of groove depth (GD) loss of the different samples of TABLE 1 after a CMP experiment in which a material was polished for 30 minutes at 50° C. Samples 2-5, which were prepared using a secondary diamine-coupled prepolymer, had a similar GD loss to the control, while Sample 1, which was prepared without using a secondary diamine-coupled prepolymer, had about 6.5-times larger GD loss than the control.

Modifications, additions, or omissions may be made to the systems, apparatuses, and methods described herein. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better explain the disclosure and does not pose a limitation on the scope of claims.

We claim:

1. A composition for preparing a chemical-mechanical polishing pad via photopolymerization, the composition comprising:
one or more acrylate urethane oligomers;
one or more acrylate monomers; and
at least one photo-polymerization initiator.

2. The composition of claim 1, further comprising one or more additives comprising at least one of: one or more stabilizers, one or more plasticizers, one or more porogen fillers, and one or more pigments.

3. The composition of claim 1, wherein the one or more acrylate urethane oligomers are formed through a reaction of an isocyanate-terminated urethane prepolymer and one or more acrylate blocking agents.

4. The composition of claim 3, wherein the one or more acrylate blocking agents comprise one or more members selected from the group consisting of 2-hydroxyethyl acrylate (HEA), 2-hydroxyethyl methacrylate (HEMA), 2-(tert-butylamino)ethyl methacrylate (TBEMA), and 3-(acryloyloxy)-2-hydroxypropyl methacrylate (AHPMA).

5. The composition of claim 3, wherein the isocyanate-terminated urethane prepolymer comprises an aromatic prepolymer or an aliphatic prepolymer.

6. The composition of claim 3, wherein the isocyanate-terminated urethane prepolymer is formed through the coupling of a secondary diamine to a urethane prepolymer.

7. The composition of claim 6, wherein a molar ratio of the secondary diamine to the urethane prepolymer is one to two.

8. The composition of claim 1, wherein the one or more acrylate monomers comprise one or more of isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), and trimethylolpropane triacrylate (TMPTA).

9. The composition of claim 1, wherein the at least one photo-polymerization initiator comprises diphenylphosphine oxide (TPO).

10. A chemical-mechanical polishing pad comprising polymerized material formed from polymerization of the composition of claim 1.

11. A method of forming a chemical-mechanical polishing pad comprising:
preparing a composition comprising:
one or more acrylate urethane oligomers;
one or more acrylate monomers; and
at least one photo-polymerization initiator; and
exposing at least a layer of the composition to ultraviolet light, thereby initiating a polymerization reaction and thus forming at least a layer of solidified pad material.

12. The method of claim 11, further comprising one or more additives comprising at least one of: one or more stabilizers, one or more plasticizers, one or more porogen fillers, and one or more pigments.

13. The method of claim 11, wherein the one or more acrylate urethane oligomers are formed through a reaction of an isocyanate-terminated urethane prepolymer and one or more acrylate blocking agents.

14. The method of claim 13, wherein the one or more acrylate blocking agents comprise one or more members selected from the group consisting of 2-hydroxyethyl acrylate (HEA), 2-hydroxyethyl methacrylate (HEMA), 2-(tert-butylamino)ethyl methacrylate (TBEMA), and 3-(acryloyloxy)-2-hydroxypropyl methacrylate (AHPMA).

15. The method of claim 13, wherein the isocyanate-terminated urethane prepolymer comprises an aromatic prepolymer or an aliphatic prepolymer.

16. The method of claim 13, wherein the isocyanate-terminated urethane prepolymer is formed through the coupling of a secondary diamine to a urethane prepolymer.

17. The method of claim 16, wherein a molar ratio of the secondary diamine to the urethane prepolymer is one to two.

18. The method of claim 11, wherein the one or more acrylate monomers comprise one or more of isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), and trimethylolpropane triacrylate (TMPTA).

19. The method of claim 11, wherein the at least one photo-polymerization initiator comprises diphenylphosphine oxide (TPO).

20. The method of claim 11, wherein preparing the composition comprises:
combining a secondary diamine to a urethane prepolymer to form an isocyanate-terminated urethane prepolymer;
combining the isocyanate-terminated urethane prepolymer with one or more acrylate blocking agents to prepare one or more acrylate urethane oligomers; and
combining the one or more acrylate urethane oligomers with one or more acrylate monomers and at least one photo-polymerization initiator.
